(19) United States
(12) Patent Application Publication
(10) Pub. No.: US 2008/0070001 A1
(43) Pub. Date: Mar. 20, 2008

(54) Plastic-acceptor hybrid components

(76) Inventors: Harri Lasarov, Espoo (FI); Pekka Kilpi, Helsinki (FI)

Correspondence Address: Hollingsworth & Funk, LLC, Suite 125, 8009 34th Avenue South, Minneapolis, MN, 55425, US

(21) Appl. No.: 11/523,140

(22) Filed: Sep. 19, 2006

(51) Int. Cl. G11B 5/64

(52) U.S. Cl. 428/141

(57) ABSTRACT

The present invention relates generally to plastic-acceptor hybrid components and, more particularly, to the direct bonding of over-moulded plastics to an acceptor insert, such as a metal, in an injection moulding tool. A method and apparatus are provided allowing the production of the present plastic-acceptor hybrid components in which the bonding of said components is obtained by anchoring the plastic component in micro-holes formed in the surface of an acceptor component.

### FIELD OF THE INVENTION

The present invention relates generally to plastic-acceptor hybrid components, and more particularly to the direct bonding of over-moulded plastics to an acceptor insert, such as a metal, in an injection moulding tool. A method and apparatus are provided allowing the production of the present plastic-acceptor hybrid components in which the bonding of said components is obtained by anchoring the plastic component in micro-holes formed in the surface of an acceptor component.

### BACKGROUND

Hybrid components are components, which are formed of different materials, such as metal and plastic. In several technical fields the application of such hybrid components is desirable, such as the production of housings for devices. Composite materials are also often used in vehicle construction, e.g. for reinforcing supporting elements. Hybrid components are particularly at their respective contact points, i.e. the area in which the two materials are connected, subjected to operational demands as well as different kind of stresses resulting from environmental influences. The use of hybrid components is generally desirable since they may offer reduced weight. In addition, certain components, such as plastic components, may offer an improved machining in comparison to e.g. a metal component.

There are various possibilities known in the art to attach two parts together forming hybrid components. This may be performed by conventional means comprising inter alia a mechanical locking, such as screwing, bolting, chemical bonding, such as gluing or taping, and combinations of mechanical and chemical means for forming a bond between two materials.

In case of gluing usually an intermediate layer of adhesive is used to bind the two components. Different kinds of adhesives have been employed as the intermediate binding layer. These adhesives include thermoplastic powders, films, webs, and hot melt adhesives, as well as thermosetting water based and solvent based liquid adhesives. Unfortunately, every adhesive employed to date comes with its own unique set of problems. For example, thermoplastic powders, films, webs and hot melts must be applied in accordance with very restrictive time and temperature parameters and yield poor heat resistance. In addition, liquid adhesives require the use of bulky and expensive spraying equipment, and related cleaning and overspray disposal systems, for effective application. Such adhesives, however, may exhibit a premature bond failure. After several years the bond formed by the adhesive fails. This causes the covering to peel and results in an unsightly product that must either be patched or replaced. Curable adhesives are for example described in U.S. Pat. No. 5,252,694, U.S. Pat. Nos. 6,180,200 and 5,897,727.

Document U.S. Pat. No. 5,601,676 is directed to a method of composite joining and repairing which includes providing complementary matching and interlocking bond line surface configurations in composite materials and the material to which the composite materials are to be bonded, interlocking the two materials at their bond line, and thereafter adhering at least one patch onto both of the surfaces of the interlocked combination of materials, thereby securing the composite to the other material. Anisotropic materials may be adhered to isotropic material.

Hybrid structural components are disclosed in document DE 10238520, including a first metal and/or plastic moulded part, bonded to at least one surface with a second moulded part on at least one surface consisting of microcellular foam in thermoplastic material and gas filled micro pores, where the mean pore diameter is up to 50 micrometer. A respective method for forming the hybrid component includes the steps of: (a) introduction of a first moulded part in metal and/or plastic into an injection moulding mould; (b) introduction of a plasticizer at over-pressure and a fluid into a thermoplastic moulding composition in the supercritical state from an injection moulding machine into an injection moulding mould; and (c) pressure release of the thermoplastic and the fluid, which form a second moulded part in the injection moulding mould having gas filled pores of mean pore diameter from 1 to 50 micrometer.

There exist, however, several inherent disadvantages to the above mentioned methods for the production of hybrid components. Often further post-assembly process steps are required, e.g. taping which needs large plastic portions for ensuring strong fixing. Gluing may offer difficulties in mass-production, particularly in maintaining a constant quality. Additionally, long curing times are needed with adhesives. Mechanical methods suffer from design limitations, in that e.g. mechanical locking requires plastic for both side of the insert increasing thickness of device.

### SUMMARY OF THE INVENTION

The present inventors have surprisingly found that by allowing a molten plastic to permeate into the surface structure, i.e. cavities, of a previously roughened acceptor component and clamping together, a hybrid component of substantially each kind of solid material with any plastic material may be obtained. By injection compression moulding of plastic onto an acceptor insert, a stable and durable plastic-acceptor hybrid component is obtained solely by anchoring of the cooled and hardened acceptor component in the roughened surface structure of the acceptor component. The present invention provides further an apparatus suitable to obtain the present hybrid component and for performing the present method.

An advantage is hereby that the roughened acceptor component does not require any other treatment in order to “accept” or “receive ” the molten plastic component in the roughened surface and to form a join between the two materials. Another advantage is that the plastic feature on the acceptor component surface is not visible to the other side of a hybrid part which is the case in conventional insert injection moulding that relays on mechanical locking of plastic through the acceptor component. A further advantage resides in that there is no limitation with regard to the used plastic and/or acceptor component, in that each kind of plastic material, which may be subjected to injection compression moulding, may be used. Still another advantage resides in high bond strengths between the plastic and acceptor component leading in case of tension applied often in breaking of the plastic component and not in breaking at the bond line, i.e. the metal-plastic interface. Injection compression moulding further produces less internal stresses into a hybrid part compared to a part that has been manufactured by using conventional insert moulding. The present method permits well defined constructions of different acceptor and plastic components for grounding or electrostatic discharge (ESD) issues.

### BRIEF DESCRIPTION OF THE DRAWINGS

FIG. 1 presents principle of injection compression moulding technology as used in the present invention.

FIG. 2 depicts the principle of conventional insert moulding technology relaying on mechanical locking in macroscopic scale.

FIG. 3 shows a schematical SEM-picture of the principle of mechanical locking underlying the present invention. Plastic melt penetrates into the micro-scale holes of a metal component and anchors therein to form a stable metal-plastic hybrid component.

FIG. 4 shows the problem of frozen skin layer on sides that prevents anchoring plastic to metal insert for conventionally injected plastic melt. The melt temperature may be up to 300° C., whereas the mould/insert temperature is typically max. 140° C. The temperature gradient prevents filling of the micro-scale holes, since a layer of partially hardened and/or viscous plastic material forms at the bond line.

FIG. 5 presents a SEM picture of a chemically etched aluminium surface by using a standard a P-2 etching method.

### DEFINITIONS

The term “hybrid component” or “composite” refers generally to a material created by the macroscopic combination of two or more distinct materials, i.e. plastic and acceptor materials, to obtain specific characteristics and properties. The components of a composite retain their identities; that is, they do not dissolve or merge completely into one another but form a defined interface area, in which the different components merge.

The terms “connected”, “coupled” or “joined” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention, in that such phrases do not necessarily refer to the same embodiment.

If the specification states a component or feature “may”, “can”, “could”, or “might” be included or have a characteristic, that particular component or feature is not required to be included or have the characteristic.

The expression “acceptor” material or component refers to any kind of material, which surface structure may be roughened in a manner to create micro-holes. Examples for such acceptor materials comprise metals, carbon fibre composites, ceramics and glass.

The term “metal” refers to, but is not limited to the pure metal, such as aluminium, beryllium, titan, copper or iron, but may be directed to any kind of alloys, such as different kind of steels, cast iron or brass.

The term “plastic” is directed to any kind of synthetic or semi-synthetic polymerization products, which are composed of organic condensation or addition polymers and may contain other substances to improve performance or economics. Plastic can be classified in many ways but most commonly by their polymer backbone (polyvinyl chloride, polyethylene, acrylic, silicone, urethane, etc.). Plastics include inter alia thermoplastics, thermosets and elastomers. Mechanical, thermal expansion and conductivity properties of plastics can be tailored by adding fillers, e.g. glass fibres, into the plastic. The only limitation is achieved by the respective moulding method, i.e. the plastic's properties should allow moulding. Examples of particular suitable plastic components comprise polyethylene, polyamides, polymethylmetacrylates, polyphenylensulfide (PPS), polyarylamides, polyurethanes, polyasetals, and polyester e.g. polybutylenterephthalate (PBT) or blends of above mentioned plastic types.

The term “roughened” refers to a pre-treatment of a material. The result of said pre-treatment is not microscopically visible since the changes in surface structure are e.g. in the range of 250 μm or less by forming cavities of maximal 250 μm depth and wide, respectively. Cavities of such sizes not visible with naked eye are also referred to as “micro-holes”. The surface may be roughened by any method known by the skilled person, e.g. by chemical etching, laser treatment and mechanical or chemical abrasion. Roughening may be performed to a desired extent, i.e. until specific average sizes of the cavities or micro holes are obtained. The micro-holes may have an average depth from 0 to 250 μm and a width from 0 to 250 μm., or an average depth of from >0 to 100 μm and a width of 0 to 100 μm, or an average depth of 0.1 to 100 μm and a width of 0.1 to 100 μm. Alternatively, they have an average depth of 0.1 to 30 μm and a width of 0.1 to 30 μm. It is to be noted that the invention is not restricted to any of these exemplary values/ranges which are only given for illustrative purposes.

The term “average size”, i.e. average wide or depth, is directed to cavities having at least 90% said value. In other words, the above term relates to a deviation of the given value, which does not exceed 10% results from the used roughening method and its accuracy.

The term “moulding” as used herein is directed to any suitable method for providing a complete or partial molten plastic part, such as injection compression moulding (ICM) or insert injection moulding. Injection compression moulding is commonly used for replicating sub-micron level plastic features from mould cavity surface mainly in manufacturing of CDs or DVDs.

Mould halves which are separately away a certain distance is intended to mould halves on which no clamping force is applied, i.e. the halves are separated or in loose contact.

### DETAILED DESCRIPTION OF EMBODIMENTS OF THE INVENTION

According to a first embodiment the present invention provides a method for the production of a plastic-acceptor hybrid component. Said method comprises (a) providing an acceptor component having a roughened surface area; (b) inserting said acceptor component into a mould cavity of an injection compression moulding tool; (c) injecting plastic into said mould cavity; subsequently applying pressure to said mould cavity; and (d) removing the plastic-acceptor hybrid component from the injection compression moulding tool.

The final compression phase, i.e. clamping or applying pressure, respectively, in which the plastic is still in a molten state, forces the plastic melt into the roughened surface structure (anchor-effect) and also gives the desired forms for plastic component in the plastic-acceptor hybrid component. Clamping may be maintained until the respective plastic-acceptor hybrid component has been hardened, in that the hybrid component may be removed from the injection compression moulding tool without affecting its shape.

It should be clear that the particular acceptor component may be already provided in its desired shape or may be alternatively shaped after formation of the hybrid components. Different methods, suitable to form plastic and acceptor parts are well known to the skilled person. Suitable acceptor components comprise also metal components, such as alloys, whereas suitable plastic components may be also a mixture of two or more different plastics. It should be clear that any type of moderate to low viscose plastics, in plastized state during injection and compression phases, may be used, i.e. each kind of plastic which may be subjected to injection compression moulding.

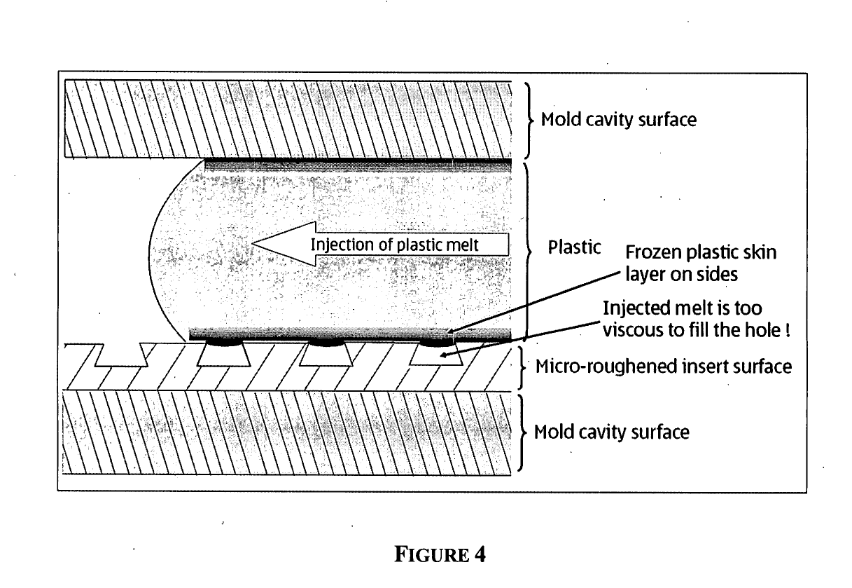

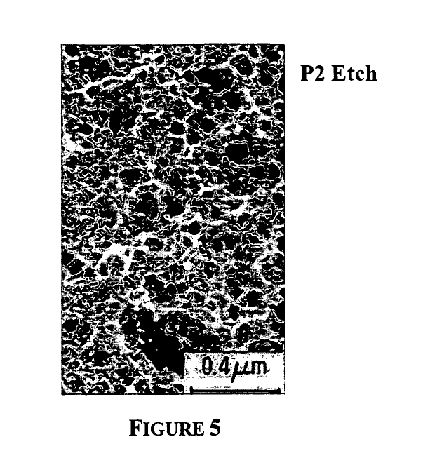

In order to favourite anchoring of the plastic melt in the roughened surface of the acceptor component, said acceptor component may be heated minimizing the temperature gradient between plastic mould and metal component, in that the temperature of mould and metal component are substantially the same or that the temperature of the metal part is for example around 10, 20, 30, 40, 50 or 60° C. lower than that of the mould temperature or between said temperatures. If the temperature of the plastic mould is for example around 200° C., the metal component will be heated to a temperature between 100 and 200° C. The injection compression moulding tool may be provided for example respective rapid heating/cooling element(s) to heat the acceptor insert above the glass transition temperature of the plastic material during clamping. The possibility for rapid cooling can accelerate a production cycle time. It is well known that the viscosity of plastic material increases remarkably above its glass transition temperature. Heating of the acceptor insert to a temperature close to that of the injected plastic melt assists in decreasing the formation of low viscose frozen skin layer as outlined for example in FIG. 4 that prevents proper filling of the micro-holes.

Plastic and acceptor component may be further fused at specific, defined surface areas. Such areas, particularly for the acceptor component, may be obtained by e.g. computer controlled laser treatment or alternatively masking areas, which shall not be subjected to chemical or mechanical abrasion.

According to another embodiment the acceptor component is selected from the group consisting of a metal, carbon fibre composites, ceramics and glass. Preparation and shaping of such acceptor components are well known to the skilled person. In exemplary embodiments said metal component is selected from the group consisting of aluminium, beryllium, titan, copper and iron.

According to an embodiment the roughened surface comprises micro-holes, having a specific size, i.e. depth and wide.

According to still another embodiment said micro-holes have an average depth from 0 to 100 μm and width from 0 to 30 μm. In an exemplary embodiment said micro-holes have an average depth of 0.1 to 100 μm and width of 0.1 to 30 μm. In another exemplary embodiment said micro-holes have an average depth of 1 to 100 μm and width of 1 to 30 μm. In still another exemplary embodiment said micro-holes have an average depth of 1 to 50 μm and width of 1 to 20 μm. In yet another exemplary embodiment said micro-holes have an average depth of 1 to 30 μm and width of 1 to 20 μm. However, any combination of depth and width can be used.

According to an embodiment of the present invention the roughened surface area is prepared by etching, sand blasting and/or laser treatment, all techniques well known to the skilled person.

According to still another embodiment the plastic component comprise polyethylene, polyamides, polymethylmetacrylates, polyphenylensulfide (PPS), polyarylamides, polyurethanes, polyasetals, and polyester e.g. polybutylenterephthalate (PBT) or blends of above mentioned plastic types.

According to another embodiment, clamping in the injection compression moulding process comprises applying a pressure in the range of 300 to 3000 bar, in an exemplary embodiment in the range of approximately 500 to 2000 bar. However, pressure could be higher or lower depending on materials and technology used. The compression force may be obtained by any suitable method, e.g. by means of clamping from the moulding machine or a pressure unit in the tool. The application of additional pressure assists hereby in entering of plastic in the respective micro-holes of the acceptor component.

According to still another embodiment the clamping is maintained for the period of time, the plastic material requires to fill the micro-holes in molten state and then harden.

According to an exemplary embodiment, an apparatus for injection compression moulding is provided, which comprises a movable mould table; a mould; and a fixed mould table. The movable and fixed mould tables are adapted to provide a clamping force to said mould. It should be clear, that alternatively both mould tables may be movable in order to provide a clamping force.

According to another embodiment, the mould comprises two mould halves. In the first of said two mould halves the acceptor component is arranged, whereas the second halve the plastic material may be inserted. The fixed side of the mould table and/or tool halve could also comprise both holding of an acceptor component and injection of plastic functions.

According to still another embodiment, said clamping force is provided by a clamping unit. Any kind of a device suitable to provide a pressing force which is known to the skilled person may be employed. The clamping unit may comprise for example hydraulic means arranged on the movable table.

According to an embodiment, the apparatus comprises a heating/cooling unit adapted for heating and cooling the acceptor component inserted in one of the mould halves. It should be clear that any kind of device suitable for heating may be provided.

According to another exemplary embodiment the present invention is directed to a plastic-acceptor hybrid component, which may be obtained by the present method. The present hybrid component comprises an acceptor component having a roughened surface area; and

a plastic component fixedly attached to said acceptor component by engaging said roughened surface area. The attachment is hereby obtained solely by means of the plastic material anchored in the surface structure of the roughened surface area, in that no other means for attachment are required.

According to another embodiment, the acceptor component is selected from the group consisting of a metal, carbon fibre composites, ceramics and glass.

According to still another embodiment, said metal component is selected from the group consisting of aluminium, beryllium, titan, copper and iron.

According to an embodiment, the roughened surface comprises micro-holes. In an exemplary embodiment said micro-holes have a depth of 0 to 100 μm and width of 0 to 30 μm.

According to an embodiment, said plastic component comprise polyethylene, polyamides, polymethylmetacrylates, polyphenylensulfide (PPS), polyarylamides, polyurethanes, polyasetals, and polyester e.g. polybutylenterephthalate (PBT) or blends of above mentioned plastic types.

The following examples illustrate the invention without limiting it thereto.

### EXAMPLES

With regard to the ICM tool used and apparatus for measuring surface tension no particular limitations exists in that each kind of device may be used, which is capable to perform the outlined method. Merely, the ICM device has to be adapted in that a clamping force may be provided.

### Example 1

In a first step a preformed steel part has been roughened by sand blasting to form micro-scale holes in an average depth of from 30 to 100 μm and width of from 15 to 30 μm. The surface structure has been checked by taking SEM-pictures (data not shown).

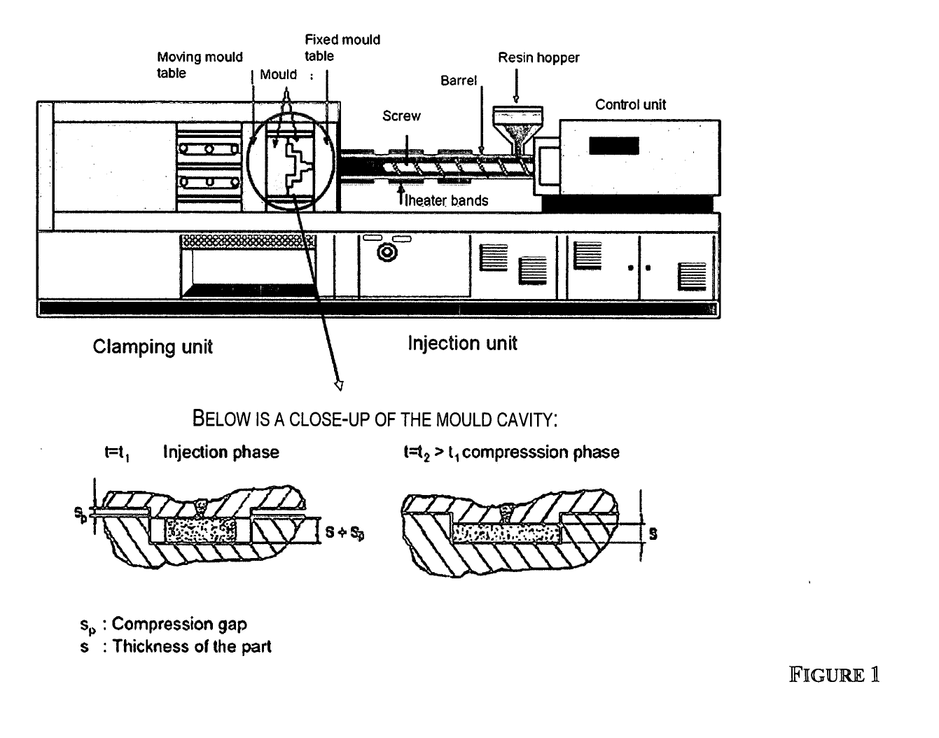

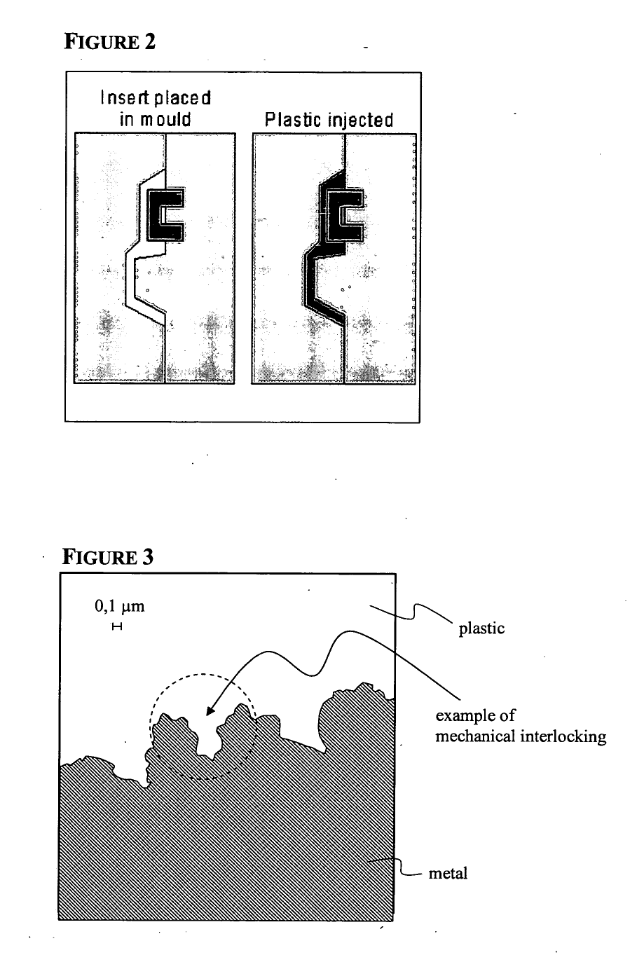

The preformed steel part has been inserted in an ICM tool as schematically depicted in FIG. 1 and a PBT melt has injected to the roughened surface after that compression/clamping phase has been started within a few seconds.

The cooled steel-PBT hybrid component has been subjected to a tension force by fixing the metal part and applying a slowly increasing mechanical pressure on the plastic part, wherein the direction of the applied force is substantially parallel to the surface of the metal part. In several tests it could be shown that PBT breaks at substantially the point at which the pressure has been applied, i.e. that the steel-PBT interface has the same or higher strength towards mechanical stresses than the PBT material itself.

### Example 2

According to the above mentioned example a steel-PPS hybrid component has been produced. Said hybrid component shows in case of application of breakage stress the same behaviour as steel-PBT hybrid component, indicating that the metal-plastic interface is more resistant towards stresses than the plastic part itself.

### Example 3 and 4

A preformed glass part of window grade has been roughened by sand blasting to form micro-scale holes in an average depth of from 30 to 100 μm and width of from 15 to 30 μm.

According to the previous examples PBT melt and PPS melt have been applied for the formation of PBT-glass and PPS-glass hybrid components. Also said hybrid components have been subjected to tension forces directed one time to the plastic part and the other time to the glass part. In both cases, plastic and glass parts have failed before breaking of the respective plastic-glass interfaces.

What is claimed is:

1. Method for the production of a plastic-acceptor hybrid component, said method comprising:
(a) providing an acceptor component having a roughened surface area;
(b) inserting said acceptor component into a mould cavity of an injection compression moulding tool;
(c) injecting plastic into said mould cavity; subsequently applying pressure to said mould cavity;
(d) removing the plastic-acceptor hybrid component from the injection compression moulding tool.

2. The method according to claim 1, wherein said roughened surface comprises micro-holes.

3. The method according to claim 2, wherein said applied pressure forces plastic melt into the micro-holes of the roughened surface of said acceptor component.

4. The method according to claim 1, wherein said acceptor component is selected from the group consisting of a metal, carbon fibre composites, ceramics and glass.

5. The method according to claim 4, wherein said metal component is selected from the group consisting of aluminium, beryllium, titan, copper and iron.

6. The method according to claim 2, wherein said micro-holes have a depth of 0 to 250 μm and width of 0 to 250 μm.

7. The method according to claim 1, wherein the roughened surface area is prepared by etching, sand blasting and/or laser treatment.

8. The method according to claim 1, wherein said plastic comprises polyethylene, polyamides, polymethylmetacrylates, polyphenylensulfide (PPS), polyarylamides, polyurethanes, polyasetals, and polyester e.g. polybutylenterephthalate (PBT) or blends thereof.

9. The method according to claim 1, wherein applied pressure is in the range of 300 to 3000 bar.

10. The method according to claim 1, wherein pressure is maintained for a period of time at which the plastic component is substantially malleable.

11. Apparatus for injection compression moulding, comprising
a movable mould table;
a mould; and
a fixed mould table; wherein the movable and fixed mould tables are adapted to provide a clamping force to said mould.

12. The apparatus according to claim 11, wherein the mould comprises two mould halves.

13. The apparatus according to claim 11, wherein said clamping force is provided by a clamping unit of a moulding machine or a clamping unit in a tool

14. The apparatus according to claim 11, comprising water or oil cooling/heating channels in a tool operated by a separate heating unit adapted for heating and cooling an acceptor component.

15. The apparatus according to claim 1 1, comprising an electrical rapid cooling/heating element assembled into the mould, adapted for heating and cooling an acceptor component.

16. Apparatus for injection compression moulding, comprising
(a) means for providing an acceptor component having a roughened surface area;
(b) means for inserting said acceptor component into a mould cavity of an injection compression moulding tool;
(c) means for injecting plastic into said mould cavity
(d) means for subsequently applying pressure to said mould cavity;
(e) means for removing the plastic-acceptor hybrid component from the injection compression moulding tool.

17. Plastic-acceptor hybrid component, comprising
an acceptor component having a roughened surface area; and
a plastic component fixedly attached to said acceptor component by engaging said roughened surface area.

18. The hybrid component according to claim 17, wherein said acceptor component is selected from the group consisting of a metal, carbon fibre composites, ceramics and glass.

19. The hybrid component according to claim 18, wherein said metal component is selected from the group consisting of aluminium, beryllium, titan, copper and iron.

20. The hybrid component according to claim 17, wherein said roughened surface comprises micro-holes.

21. The hybrid component according to claim 20, wherein said micro-holes have a depth of 0 to 250 μm and width of 0 to 250 μm.

22. The method according to claim 17, wherein said plastic component comprises polyethylene, polyamides, polymethylmetacrylates, polyphenylensulfide (PPS), polyarylamides, polyurethanes, polyasetals, and polyester e.g. polybutylenterephthalate (PBT) or blends thereof.
